(19) United States
(12) Patent Application Publication
(10) Pub. No.: US 2018/0268305 A1
(43) Pub. Date: Sep. 20, 2018

(54) RETROSPECTIVE EVENT VERIFICATION USING COGNITIVE REASONING AND ANALYSIS

(71) Applicant: INTERNATIONAL BUSINESS MACHINES CORPORATION, ARMONK, NY (US)

(72) Inventors: Amol A. Dhondse, Kothrud (IN); Anand Pikle, Pune (IN); Stephen J. Price, Tampa, FL (US); Krishnan K. Ramachandran, Campbell, CA (US); Gandhi Sivakumar, Victoria (AU)

(21) Appl. No.: 15/463,693

(22) Filed: Mar. 20, 2017

(51) Int. Cl. G06N 5/04; G06F 17/30; G06Q 40/08; G06N 99/00

(52) U.S. Cl. CPC G06N 5/04; G06F 17/30309; G06N 99/005; G06Q 40/08; G06F 17/30371

(57) ABSTRACT

The factual accuracy of an event is verified. Event data is received by a computer, whereby the event data includes actor data related to at least one actor involved in the event and location data related to a location of the event. A factual scenario is created based on the event data. A cognitive reasoning and analysis of the event data is performed to derive inferences regarding the event and a time-sequenced series of inferences is composed based on the cognitive reasoning and analysis of the event data. Integrity of the event data is validated by comparing a data points from different sources and at least one flag is prompted when an instance of factual inconsistency is identified by the step of validating the integrity. A rendering of the event is generated based on the factual scenario and the time-sequenced series of inferences.

### FIELD OF THE INVENTION

The present disclosure relates generally to event verification, and more particularly to a method and system for verifying a factual scenario by using cognitive reasoning and analysis to compare parameters and data extracted from external sources.

### BACKGROUND OF THE INVENTION

Event verification can include redundancy and delay while various parties (legal defendants, policyholders, insurers, etc.) collect event information. For example, when a policyholder submits a claim, inevitably additional information is required by the insurance provider to process the claim and the policyholder must typically wait on approval from either, or both, of the insurer or the repair facility before the claim can be processed and the damage repaired. Similarly, police investigations involve numerous factual scenarios including multiple witnesses and regulatory issues which are difficult to reconcile.

In the field of event verification, whether in the arena of insurance claim processing or police investigations, the trend is toward cognitive models that consider past events, interaction with humans and other factors to learn and refine future responses.

Typical insurance claim processing requires the policyholder initiate the insurance claim and makes an initial trip to a repair facility for a preliminary damage assessment. Police reports are often involved with one or more witnesses having facts that might impact the insurance claim or the fault issue. Some insurers provide for online/electronic initiation and submission of insurance claims. Online claim submission does not resolve the burden on the policyholder of having to submit redundant information or coordinating information exchange between the insurer and the repair facility. Also, with online claim submissions there is an increase likelihood of fraudulent claims. Because there is often some delay between the claim event (e.g., car accident) and the time the policyholder files the claim, the insurer is unable to confirm that damage to the policyholder's property is a result of the accident, as claimed, or whether the damage occurred later and is unrelated to the accident. Similarly, online claim submissions do not resolve the delay associated with the repair facility assessment and claim estimator inspection.

### SUMMARY OF THE INVENTION

A method and system is provided for verifying the factual accuracy of an event. Event data is received into a computer. The event data includes actor data related to at least one actor involved in the event and location data related to a location of the event. A factual scenario is created based on the event data. A cognitive reasoning and analysis is performed on the event data to derive inferences regarding the event and a time-sequenced series of inferences is composed based on said cognitive reasoning and analysis of the event data. Integrity of the event data is validated by comparing a plurality of data points from different sources and at least one flag is prompted when an instance of factual inconsistency is identified by the step of validating the integrity. A rendering of the event is generated based on the factual scenario and the time-sequenced series of inferences, wherein the rendering includes the flag generated during said step of prompting to identify any factual inconsistency.

### BRIEF DESCRIPTION OF THE DRAWINGS

FIG. 1 illustrates the main components of operating environment for an event processing system in accordance with embodiments of the present invention.

FIG. 2 illustrates the implementation architecture in accordance with embodiment of the present invention.

FIG. 3 illustrates the implementation steps in accordance with one embodiment of the present invention.

FIG. 4 illustrates a system for employing the cognitive approach to event verification in accordance with one embodiment of the present invention.

FIG. 4a illustrates a flowchart for employing the cognitive approach to event verification in accordance with another embodiment of the present invention.

FIG. 5 illustrates a computer system used for implementing the methods of the present invention.

### DETAILED DESCRIPTION OF THE EMBODIMENTS

Conventional methods for processing an insurance claim are not efficient, convenient, and effective in collecting all information necessary to accurately and quickly processing an insurance claim. Similarly, the legal ramifications of an accident event call for evaluation of the credibility of the persons involved as well as the information provided by witnesses.

No system exists for evaluating a sequence of events and highlighting factual anomalies in the evidence while identifying and mapping of the event sequences and creating event inferences based on self-learning from historical data points and models stored in a repository.

The present disclosure provides an event processing system and method that facilitates accurate and convenient fact processing using an electronic device to collect the information necessary for relevant personnel, such as an insurance provider or a police officer, to process the factual validity of the event. For example, the invention collates information from various eye-witnesses, local, social and environmental sources using the data collector to compose the sequence of events and related behavioural influences. In case of multiple factual accounts, the cognitive mapper and executor compares the processed information from different selected versions (ex. eye witness testimonies) and enables violation reporting including drill through analysis, i.e. zoomed internal difference in statements. For example, in the first iteration of the vigilance inquiry the actor's testimony included the statement, “I was walking towards South Road in the left side of the road and saw a lady coming in front of me. It was snowing and was 3 pm and was dark”. In the third iteration, the actor stated “I was standing in front of Allen Florist in South Road and saw a lady coming. It was 5 pm.” The apparatus compares the testimonies with the text/video output composed of the inferred sequence of events/frames, and factual errors or violations are reported for the inconsistent or differing statement by the computing system and the system provides output as an audio, text or video format.

The overall system architecture as well as the use of a mobile computing device in conjunction with an insurer server is described. It is contemplated that the described system may be used to process insurance claims, crime scenes, or other factual scenarios of import. As used throughout the specification, “objects” should be interpreted to include any tangible person or object involved in the event. In an exemplary embodiment, such “objects” can include any type of vehicle, such as, automobiles, boats, recreational vehicles, motorcycles, and bicycles, as well as other forms of personal property including the user's home, jewelry, personal electronics, etc. The exemplary embodiments analyze information provided regarding the object and the relevant scene or environment for the object, generate a model of the object, and identify factual information related to the object.

Using the information regarding the object, the event processing system may be used to determine various elements of the reported facts (e.g., weather, time, location, legal and/or regulatory specifications, etc.) and provide an initial event assessment. Exemplary embodiments may query the user when the information necessary for processing the event is insufficient or when further information is required to estimate the validity of certain factual assertions made by the actors and/or the user attempting to validate the event. As a result, through this iterative process of requesting information, the user is able to provide more complete event data and the event may be processed more efficiently.

In accordance with this invention, a computer program product is provided for processing and evaluating the factual validity of an event, the computer program product having a computer-readable storage device with computer-readable program instructions stored therein for: receiving user data associated with the even, the user data including a factual of the event from an actor; comparing the user data with third-party data such as weather reports and legal and/or regulatory data for the location of the event; performing cognitive reasoning and analysis on the received user and third-party data; generating integrity prompts based on the accuracy and validity of the user and third-party data; and generating a model of the scene of the event using the user data and the third-party data. The computer program can output a complete audio, video and/or textual analysis of the data and facts associated with the event with analysis of any inconsistencies or anomalies associated with the data being analyzed.

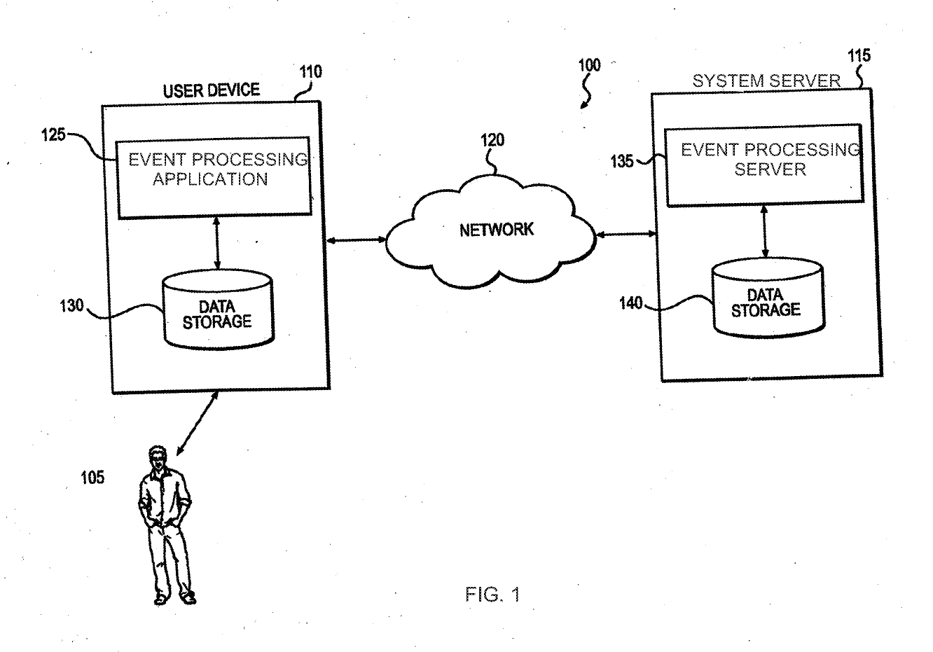

FIG. 1 illustrates the main components of operating environment 100 for an event processing system in accordance with certain exemplary embodiments. The event processing system can be embodied as a stand-alone application program or as a companion program to a web browser having messaging and storage capabilities. While certain embodiments are described in which parts of the event processing system are implemented in software, it will be appreciated that one or more acts or functions of the event processing system may be performed by hardware, software, or a combination thereof, as may be embodied in one or more computing systems.

The exemplary operating environment 100 includes a user device 110 associated with a user 105, and system server 115, and a network 120. The user device 110 may be a personal computer or a mobile device, (for example, notebook computer, tablet computer, netbook computer, personal digital assistant (PDA), video game device, GPS locator device, cellular telephone, smartphone, camera, or other mobile device), or other appropriate technology. The user device 110 may include or be coupled to a web browser, such as Microsoft Internet Explorer® for accessing the network 120. The network 120 includes a wired or wireless telecommunication system or device by which network devices (including user device 110 and system server 115) can exchange data. For example, the network 120 can include a telecommunications network, a local area network (LAN), a wide area network (WAN), an intranet, an Internet, or any combination thereof. It will be appreciated that the network connections disclosed are exemplary and other means of establishing a communications link between the user device 110 and the system server 115 can be used.

The user device 110 includes an event processing application 125 including various routines, sub-routines, programs, objects, components, data structures, etc., which perform particular tasks or implement particular abstract data types. The exemplary event processing application 125 can facilitate collection of data from the user 105 necessary for processing an event sequence. An event sequence can be initiated at the user device 110 using the event processing application 125. The exemplary event processing application 125, using via the network 120, can send and receive data between the user device 110 and the system server 115. The exemplary event processing application 125 can also interact with a web browser application resident on the user device 110 or can be embodied as a companion application of a web browser application. In a web browser companion application embodiment, the user interface of the event processing application 125 can be provided via the web browser.

The event processing application 125 can provide a user interface via the user device 110 for collecting and displaying data relevant to the event. Using the user device 110 and the event processing application 125, the user 105 can input, capture, view, download, upload, edit, and otherwise access and manipulate user data regarding an event. Throughout the discussion of exemplary embodiments, it should be understood that the terms “data” and “information” are used interchangeably herein to refer to text, images, audio, video, metadata or any other form of information that can exist in a computer-based environment. The user 105 can enter commands and information to the event processing application 125 through input devices, such as a touch screen, keyboard, pointing device, and camera. The pointing device can include a mouse, a trackball, a stylus/electronic pen that can be used in conjunction with user device 110. Input devices can also include any other input device, such as a microphone, joystick, game pad, or the like. The camera can include a still camera or a video camera, a stereoscopic camera, a two-dimensional or three-dimensional camera, or any other form of camera device for capturing images of the object/scene of interest. In an exemplary embodiment, the camera is an integral component of the user device 110. In an alternate embodiment, the input device is coupled to the user device 110. In an exemplary embodiment, the user device 110 can include GPS or similar capabilities to provide user device 110 location information.

The user device 110 can include an integral display. The display can provide images and information associated with the event processing application 125 to the user 105. In an exemplary embodiment, the user 105 can view and manipulate the images illustrated on the display. For example, the user 105 can pan, zoom, rotate, and highlight the image and/or portions of the image. In an alternate embodiment, the user device 110 can include a monitor connected to the user device 110. In addition to the display, the user device 110 can include other peripheral output devices, such as speakers and a printer.

The exemplary event processing application 125 enables storage of user data associated with the event at a data storage unit 130 accessible by the event processing application 125. The exemplary data storage unit 130 can include one or more tangible computer-readable storage devices resident on the user device 110 or logically coupled to the user device 110. For example, the data storage unit 130 can include on-board flash memory and/or one or more removable memory cards or removable flash memory.

The exemplary operating environment 100 also includes a system server 115. The system server can be operated by the user and can provide event processing and data storage. The system server 115 can include one or more computer systems. An exemplary computer system can include an event processing server 135, a data storage unit 140, and a system bus that couples system components, including the data storage unit 140, to the event processing server 135.

While the user 105 can interact with the event processing application 125 via the user device 110 to add, modify, or remove user data, the user 105 can similarly interact with the system server 115. The event processing server 135 also provides the user with the ability to add, modify, or remove data associated with the event sequence. The event processing server 135 also has the ability to communicate/query the user 105 via the event processing application 125. In return, the event processing application 125 allows the user 105 to input and respond to queries provided via the system server 115.

As set forth herein, the present invention is directed to a method for processing a sequence of events; for example, an insurance claim, an accident or a crime scene. An aspect of the present invention provides a computer-implemented method for processing a factual event, for verifying various parameters (time and location) based on an assertion of reported fact, and for comparing the parameters to data extracted from external sources (e.g., weather data, photographic images, videos, etc.). The invention further proposes to provide a method and system for running a sequence of events and highlighting the root cause of the event textually, identifying correlations based on related events, mapping the event, and creating event sequences based on self-learning techniques based on historical data points and models stored electronically.

Another aspect of the present invention provides a mobile computing device. The desktop or mobile computing device can include a processor, a computer-readable media, a memory storage device, and an event processing application. The event processing application can be stored on the memory storage device for execution via the computer-readable media. The event processing application can be configured to: receive data from an actor or actors associated with an event, the user data including an image of an object or scene involved in the event; transmit the actors' data to a remote server; generate a model of the object or scene of the event from the remote server, provide an indication corresponding to the factual accuracy of the event and the reported facts.

Another aspect of the present invention provides an event server. The event processing server can include a processor, a computer-readable media, a memory storage device for storing and providing access to data that is related to an event, and an event processing application. The event processing application can be stored on the memory storage device for execution by the computer-readable media. The event processing application can be configured to include a: data collector to collect relevant data such a case history, weather and local data, actor behavior and witness testimony; a raw data processor for filtering the event data from internal and external commercial sources such as legal and regulatory sources into a structured taxonomy for further analysis; a natural language classification engine to translate actor characteristics into action mapping; a data segment analyzer to enable behavior-based insight into event data and related dimensions; a cognitive modeller for performing cognitive reasoning and analysis based on the processed data and deriving inferences about the event. The inferences may include a list of possible scenarios that are derived from past events stored by the computer. In accordance with the invention, the system is able to retrieve past data of events having similar or related facts and derive a list of possible scenarios of the present event based on similar factual scenarios stored from the past events. The invention may further include: a character mapping and video augmenter for deriving insights based on the actor's actions to build profile characteristics of the actor in order to reason and extract behavioural inferences. Again, these inferences may be a list of possible scenarios derived from stored historical data having similar fact patterns or related facts. A retrospective composition steward may be used to compose a structured and time-sequenced series of inferences about the event across multiple dimensions such as road conditions, visibility, human distraction, etc., where an inference is defined at least one possible scenarios derived by the system based on past or historical events having the same, similar or related facts to the current event being analysed.

In accordance with this invention, a cognitive mapper and extractor may be employed to map and validate the integrity of the reported data (e.g., eye-witness reports, damage reports, injury reports, etc.) and generate a fact-violation indication or flag if such exists. The cognitive extractor engine also validates the integrity of the reported facts based on stored legal and regulatory data such as speed limits, motor vehicle administration rules, road closures, etc.

The method and system of the invention provides an output in audio, video and/or text modes whereby the recorded data is used to create a character object taking into account the relevant data and maps the event with input from the cognitive mapper and executor.

Thus, the invention overcomes the limitations in the prior art by accounting for complex situational factors as well as legal and regulatory information to provide text and/or video highlighting of factual inconsistencies and integrity issues.

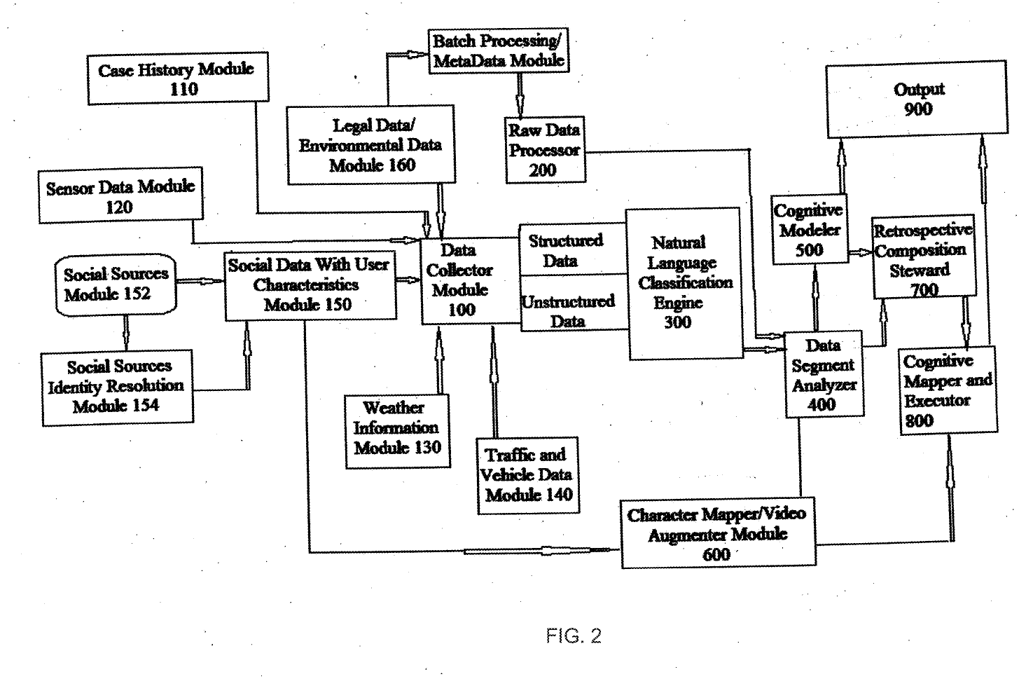

With reference to FIG. 2, the implementation steps for the invention architecture are shown in the form of a block diagram. The invention may comprise a data collector 100 designed to receive data from a number of sources including a case history module 110, sensor data module 120, a weather information module 130, a traffic and vehicle data module 140, a social data module 150, and a legal/regulatory data module 160. These data modules 110-160 are provided by way of example only and are not intended to limit the scope of the present invention. All of these data sources 110-160 provide data to the data collector 100 in order to perform a comprehensive analysis and cross-verification of various facts related to the event at hand. The data collector 100 captures data related to an actor such as background information, social behavior, relevant real-time information such as other actors, vehicles, etc. relevant to a scene or event, and event surroundings such as weather, light conditions, traffic and other local information available via an application programming interface (API). As known to those of skill in the art, an application programming interface is a set of subroutine definitions, protocols, and tools for building software and applications. The API makes it easier to develop a program by providing all the building blocks, which are then put together by the programmer. An API may be for a web-based system, operating system, database system, computer hardware, or software library.

The case history module 110 may include data recorded by a user or downloaded from various operators of the system. For example, the case history module 110 may include eye-witness accounts of a particular event, user input from an accident or crime scene, police officer input, insurance adjuster input, etc. The sensor data module 120 provides data from sensors that form part of an event sequence such as temperature, humidity, vehicle speed, and other data that may be electronically detected by a sensor. The weather information module 130 provides data related to the weather characteristics of the scene of the event of interest, which may be compiled from public records, sensors, weather stations, weather services, and other sources. The traffic and vehicle data module 140 provide data received from traffic reports, online traffic monitoring systems, accident reports, etc., as well as vehicle data (e.g., make, model, color, etc.) that may be downloaded from memory device installed on a vehicle related to the event of interest. It will be understood that numerous sources of traffic data may be encompassed by this invention, and the vehicle data may be downloaded using known techniques available to those familiar with vehicle memory devices.

The social data module 150 compiles data from numerous social sources 152 such as social media, dating web sites, personal profiles on web pages in general, etc. whereby a social source identity resolution module 154 is provided to reconcile different data received into the social data module 150. As will be described in more detail below, the social data module 150 may also communicate with the character mapper/video augmenter 600 to further reconcile personal data related to an actor for an event of interest. User or actor characteristics and related history are compiled and relayed to the data collector 100 through the social data module 150 to provide a comprehensive source of information related to the actors involved in or present at an event of interest.

The data collector 100 further receives data from a legal/regulatory data module 160 which stores information from sources of legal and regulatory specifications such as road closures, HOV restrictions, speed limits, hours of operation, handgun laws, drug paraphernalia laws, local ordinances, regulations, etc. The legal and regulatory specifications may be used to cross-check other data being compiled by the data collector 100 regarding objects and actors relevant to the event.

In accordance with this invention, it will be understood that the data collector 100 collects data from a variety of sources such as: case history (ex: insurance incident or vigilance reporting from an officer of the law, an insurance adjuster, a case worker, etc.), weather and local data, vehicle data, legal and regulatory data, user activity data such as social behavior and eye-witness testimonies. The system will verify the data and provide adaptive learning through the cognitive modeller 500 and cognitive mapper and executer 800 to provide a cognitive model for event verification.

A raw data processor 200 filters the description data of the environment and situations (time, location, events, etc.) and retrieves the relevant structured data from internal or commercial sources. The raw data processor 200 further retrieves legal and regulatory specifications as appropriate and transforms and normalizes the data from multiple sources in to a structured taxonomy for further analysis. Thus, the raw data processor 200 processes and transforms information from disparate sources into a cohesive knowledge base at an appropriate level of aggregation and associated to suitable dimension, including time and geo-coordinates.

A natural language classification engine 300 uses natural language interpretation and classification capabilities on structured and unstructured data to perform user characteristic to action mapping. For example, the natural language classification engine 300 uses natural language processing to map text, audio and video information to relevant attributes that qualify a situation so that the information can be tagged to the sequence of events. For example, a camera may capture a pedestrian running across a street and the classification engine 300 may tag the event and frames with key words such as “unexpected obstacle,” “sight obstruction,” “hazard,” and so on to provide natural language contextual tags to an event.

A data segment analyzer 400 performs multi-dimensional data aggregation and network relationship analysis to enable behaviour based insights about the event and related dimensions. The data segment analyzer 400 analyzes and executes aggregate information and uses analytical models to determine possible correlations between events and behaviors, such as—person X was distracted.

A cognitive modeller 500 performs cognitive reasoning and analysis on the processed data for co-relation and deriving inferences about the incident or event. For example, the cognitive modeller 500 performs supervised training to self-learn from historical data and hypothesizes possible scenarios that may have occurred, such as the condition of a road surface and visibility at a scene.

A character mapper/video augmenter 600 leverages insights from activities of the relevant actor to build profile characteristics of the actor in order to reason and extract behavioural inferences. For example, the augmenter 600 may use cognitive techniques to build a behavioural profile of the actor based on past actions and events, such as an actor's tendencies to be late, to speed, to text while driving, etc. As previously mentioned, the augmenter 600 may work in conjunction with the user characteristics module 150 to reconcile personal information, habits, characteristics, traits, history, and relationships.

A retrospective composition steward 700 composes a structured and time-sequenced series of inferences about the event across multiple dimensions such as road condition, visibility, human distraction, etc. The retrospective composition steward 700 compiles various sequences of events with inferred information and related metadata to form a logical and cohesive depiction of happenings related to a particular event over a particular period of time.

A cognitive mapper and executor 800 maps and validates the integrity of the description data (ex. eye-witness reports, case history) and prompts with anomaly any integrity violation (considering such factors as environment, personal data, etc.). The related executor engine validates the integrity of the description with legal and regulatory principles and marks such as a violation. It is noted that a sequence of phases of validation can be configured. For example, cognitive mapper and executor 800 uses machine learning techniques to identify anomalies and outlier data points in the inferred information about a sequence of events by comparing the expected inferences and behaviors in a normal condition with respect to the regulatory and legal requirements/guidelines. Appropriate flags are then applied to identify anomalies.

The method and system of this invention further provides an output in an audio, video and/or text mode 900 by creating a primary character object using the description data and personal data, creating surrounding character objects using the description data, creating dynamic animation picking the verbs in the unstructured data, and mapping any violations with flags in the video frames with input from the cognitive mapper and executor 800. The output 900 reconstructs and renders the output by depicted the complete sequence of events along with inferred dimensions and any anomaly information in text, audio and/or video format depending on the appropriate and desired format.

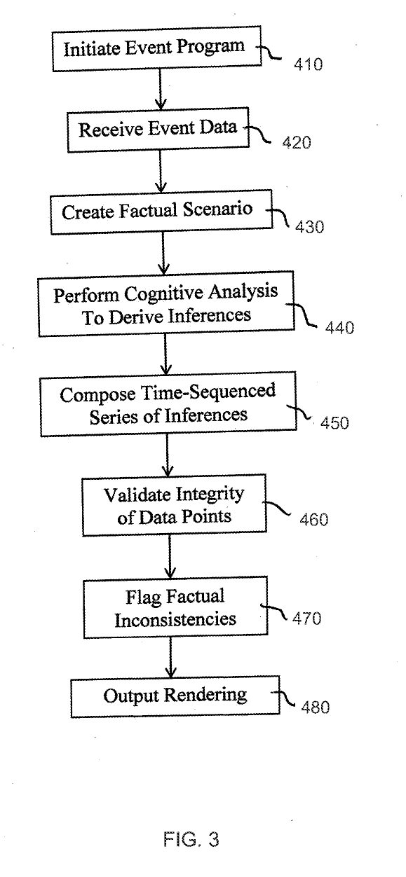

FIG. 3 illustrates the implementation steps in accordance with one embodiment of the present invention. At step 410, the event program for verifying a factual scenario is initiated in order to produce a desired output in the form of a rendering. At step 420, the event program receives the event data including data related to at least one actor involved in the event and location data for the scene of the event. As previously described, a plurality of data modules 110-160 deliver data to the data collector module 100, including sensor data, weather data, traffic data, legal data, case history data, and social data.

Next, the system creates a factual scenario at step 430 based on the data collected by the data collector 100. The factual scenario is an accumulation of the underlying facts surrounding an event that are later analysed to derive inferences as will be described below.

At step 440, the system next delivers raw data, structured data, and unstructured data to cognitive modeller 500m data segment analyser 400, and cognitive mapper 800 to perform a cognitive reasoning and analysis on the data to derive inferences about the event.

At step 450, the system composes a time-sequenced series of inferences based on the cognitive reasoning and analysis. For example, the system may derive the possible conditions of a road surface based on weather, the possible visibility of a witness due to weather, or an actor's physical condition based on related events or facts.

At step 460, the system compares data from different sources to validate the integrity of the data collected for a particular event. For example, the factual data from different eye-witnesses may be compared for factual inconsistencies or the factual account of a witness may be compared to related facts from other sources such as the weather. At step 470, the factual inconsistencies identified by step 460 are flagged or otherwise noted.

At step 480, a rendering of the event is output in the manner described above with factual data and inferences being included along with the flagged factual inconsistencies to give insight into an event for a person who is reviewing the event for factual accuracy and consistency. The rendering may be output in audio, video and/or text format.

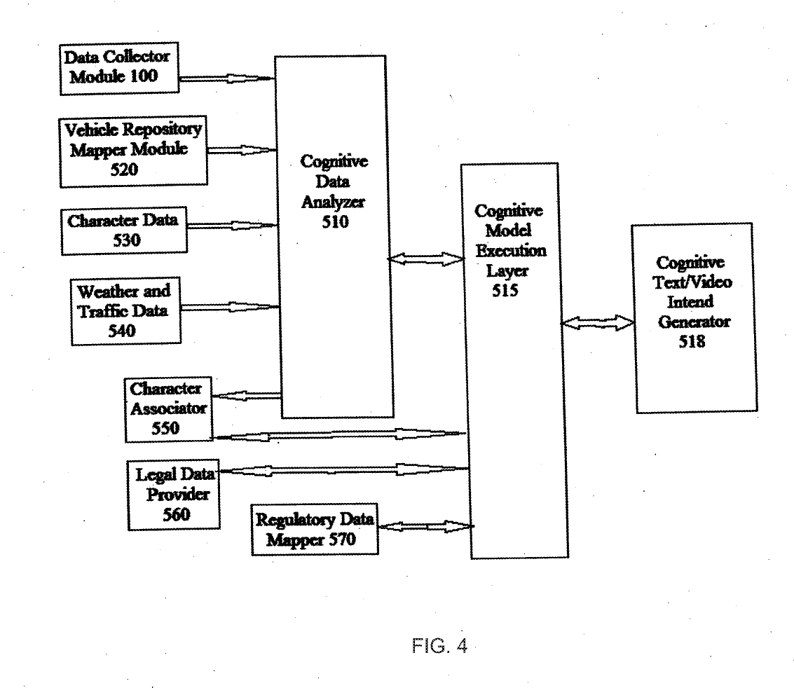

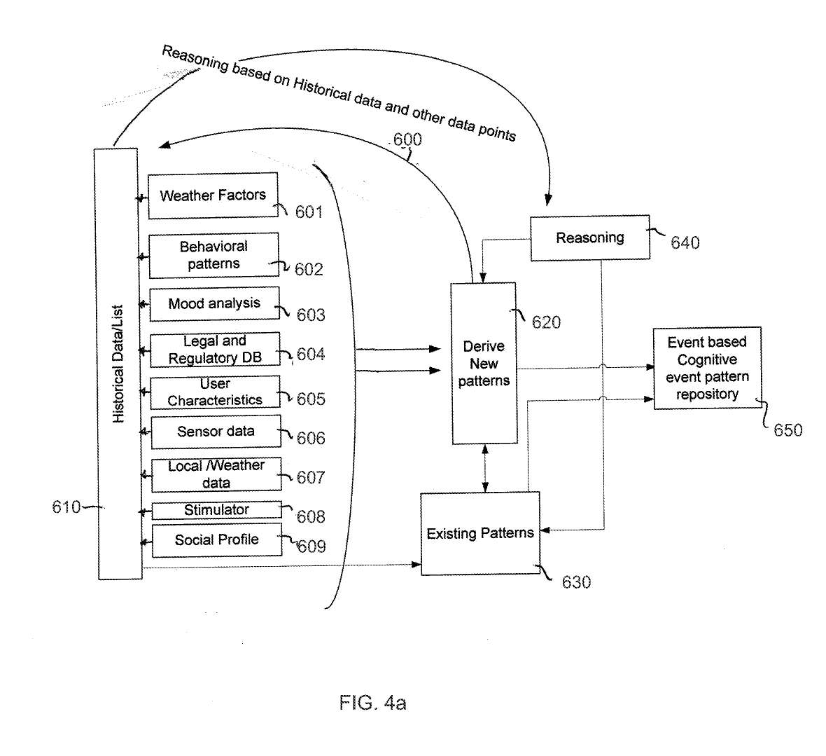

FIG. 4 illustrates a system for employing the cognitive approach to event verification in accordance with this invention, whereby a cognitive data analyzer 510 receives data from various exemplary sources such as the data collector 100, a vehicle repository mapper 520, character data 530, and weather/traffic data 540. The cognitive data analyzer 510 will also communicate with character association module 550 information related to the character data 530. A cognitive model execution layer (CMEL) 515 will receive information from the cognitive data analyzer 510 as well as information regarding legal and regulatory data 560, 570 to qualify information delivered to and processed by a cognitive text/video intends generator 518 which generates respective videos and textual information that is outputted by the system.

Based on the above discussion of the architecture for the system and method of the present invention, the benefits provided by the present invention will be readily apparent based on the following hypothetical example. In the exemplary scenario, an actor named Carl is involved in a single car accident after Carl successfully avoided striking a pedestrian named Betty, who was crossing a street. Using an insurance industry example, the inventive architecture of the present invention will be described. A user will employ the event verification system of the present invention to input and receive data relevant to Carl's automobile accident. In this example, an accident has been reported and the deliberations on the nature of the accident have been reported. With additional evidence gathered by the user; e.g., an insurance inspector, and publicly available data regarding weather and road conditions, the insurance company (or a police officer evaluating the scene) may further evaluate and qualify the claims and potential award of benefits.

First, the data collector 100 collects details of the case including, but not limited to, time, date, weather conditions, location data, eye-witness testimony, actions of the actors involved; e.g. Carl and Betty, the actors personal background information, social behavior, traffic conditions, as well as legal and regulatory data related to the scene. The data collector 100 captures data related to Carl such as his background, social behavior for example on social media, his physical characteristics, health, etc. The data collector 100 additionally captures data related to the surrounding such as weather, lighting conditions, traffic details, local laws, regulations and ordinances. For this example, evidence related to Carl's vehicle will be collected but it will be understood that other articles of interest at a particular scene may be important to the event verification and analysis such as clothing, personal items, weapons, etc. The data collector 100 will also receive evidence related to real-time information such as eye-witnesses, pedestrians, other vehicles, and so on.

The raw data processor 200 filters the collected data from the data collector 100 related to environment, time, location, actors, and retrieves relevant structured data from internal and/or commercial sources, such as laws, regulations and ordinances. The raw data processor 200 transforms and normalizes the data from disparate sources into a structured taxonomy for further analysis.

The natural language classification engine 300 uses natural language interpretation and classification capabilities on structured and unstructured data to perform action mapping. For example, natural language processing may be employed to map textual, audio and video information to relevant attributes that qualify an event and may be tagged to elements of the event. In this example, a video camera may have captured a pedestrian running across the street near Carl's accident and the system may tag the relevant video frame(s) with keywords “unexpected obstacle,” “sight obstruction,” “hazard,” etc. to provide context to the evidence at hand.

The data segment analyzer 400 performs data aggregation and network relationship analysis to enable behavior-based insights into an event and related dimensions. For this example, the data segment analyzer 400 may determine correlations between events and Carl's behavior and infer a characteristic or action for Carl, such as “Carl may have been distracted,” “Carl's vision may have been impaired,” and/or “Carl's vision is 60/100” to assist the user in evaluating possible accident scenarios.

Based on the foregoing data collection and analysis, the cognitive modeller 500 may be employed to perform cognitive reasoning and analysis on the processed data for deriving inferences about the event. For example, the cognitive modeller 500 may use supervised training to self-learn from collected data and hypothesize possible scenarios that may have occurred, such as “the intersection may have been slippery due to potential oil spillage and given that it had rained the previous hour.” Likewise, the system could hypothesize based on collected data that “due to fog, Carl's visibility was limited to 50 feet.” These types of inferences may give insight to someone trying to assess an entire event sequence while comparing different scenarios.

The character mapper and video augmenter 600 builds profile characteristics of an actor, like Carl, in order to reason and extract behavioural inferences. The augmenter 600 employs cognitive analysis to create a profile of the actor based on past history and real-time data to infer a possible behavior of the actor, such as “Carl is typically an alert and law-abiding driver, who may be prone to occasional distraction such as texting while driving, and Carl was running late for a concert on the day in question.”

The retrospective composition steward 700 then composes a structured and time-sequenced series of inferences about the event across multiple dimensions such as road conditions, visibility, human distraction, to form a logical and cohesive depiction of happenings during a certain span of time.

The cognitive mapper and executor 800 validates the integrity of the collected data in light of the inferred circumstances and behaviors, and prompts integrity violations considering environmental and personal data. Additionally, the gathered evidence is validates against relevant legal and regulatory principles for potential violations. Thus, the cognitive mapper and executor 800 uses machine learning techniques to identify outlier and anomalous data points in the inferred information in the sequence of events by way of expected behavior in normal conditions as well as legal and regulatory requirements.

The cognitive modeller 500 and cognitive mapper and executor 800 then deliver processed information to output 900 in text, video, and/or audio modes. The output 900 creates a primary character object using the event data and personal data for the actor(s), creates surrounding character objects using the event data, and may create dynamic animation picking verbs in the unstructured data. The output 900 maps anomalies and factual inconsistencies in the text, video and/or audio segments with input from the cognitive mapper and executor 800. In this example, the system reconstructs and renders the output depicting the complete sequence of events along with inferred dimensions and identified anomalies, for example, Carl's journey from 20 minutes prior to the accident to 10 minutes after the accident. Here, the output 90 may depict, using video, the pedestrian crossing the street relative to Carl's timeline, may indicate Carl's speed of travel, may identify inferences such as slippery road conditions and poor visibility. The system may further indicate that Carl may have been in a hurry because he was running late for a concert or may have been extremely distracted prior to beginning his trip. Eye-witness accounts may be verified and facts asserted therein may be checked for inconsistencies and noted appropriately by the output 900. Notably, the output 900 would flag or otherwise identify all anomalies and inconsistencies in the data, facts, and evidence gathered by the system in light of inferences derived by the cognitive analysis to present an accurate rendering of a real-time sequence of events.

From the foregoing description it will be apparent from those of ordinary skill in the art that the present invention provides a system for analyzing an event defined by those involved, e.g., actors, witnesses, an officer, insurance employee or vigilance representative, etc., whereby the event description is used by the cognitive model as a base and is qualified by various pipelines including legal and regulatory, external environment repository by the Cognitive Model Execution Layer (CMEL) 500 which will help to generate video images via Cognitive Advisor and Video Generator (CAVG) 600 which generates retrospective video. Video and/or text based outputs may be generated with violations by the CMEL 500 and cognitive mapper and executer 800. This system will help insurance companies, legal bodies, officers of the laws, case workers and others to understand situations in better way and make decisions in smarter, faster and more accurate manner.

The current limitations of retrospective cognitive models can be overcome by the “Retrospective Cognitive Agent” (RPA) method and apparatus described by this invention and encompassing the following capabilities:

1. The ability to extract the described facts and factors and validate those facts and factors with historical databases. For example when a case is described as “It was 5 pm on 18^{th} Jan. and I was driving my car in Nepean Highway towards Frankston. It was raining heavily and visibility was poor.” The system of this invention will extract evidence related to the described facts and factors and build a “described factors to validation map”. The system will then double-check the facts asserted by the relevant actors involved in the relevant event and issues flags or warning when the facts cannot be validated.

2. The ability to continuously refine the described factor to validation map via paraphrasing techniques.

3. The ability to validate the environment described factors with external sources and validate and qualify the asserted facts for integrity.

4. The ability to define a “legal and regulatory factor map” (LRFM) in the context of time and location to validate facts entered into the system.

5. The ability to qualify prompts with LRFM pipeline: Ex: Case description was specified as “I was driving a truck at 4:00 PM on 18th Jan. in Nepean highway . . . ”. The output of LRFM will output “driver violation” with red alert because truck is not permitted on Nepean highway until 5:00 pm as per the pertinent regulatory conditions.

6. The ability to qualify prompts of integrity violations as a result of qualification by “environment description pipeline” Ex: a witness states: “It was raining heavily at 5:00 pm on the 18^{th} of January and visibility was poor.” The validation pipeline will report a violation because the weather information source 140 indicates that the rain stopped at 3:00 pm in the specified location.

7. The ability to qualify actor characteristics with specific case description entered into the system for validation.

8. The ability, for video specific outputs, to create character data leveraging the customer or character information ex: download and evaluate the customer information (e.g., gender, age and link to the image library) and based on the data the system will create a representation of the character in video format.

9. The ability to input natural information directly or indirectly on the event. Example: “It was raining when I was driving or I was driving in Nepean highway and visibility was poor. It was 5:00 pm.” The system will use this information and collect details about the fog and simulate the background in the media frame to assist the user in evaluation of the event and the scene of the event.

10. The ability to download and evaluate vehicle details and define the same from the image library. Example: convertible hatch back vehicle, via model to image maps.

11. The ability to create other characters as defined in the natural language classification engine 300 using external factors to image map. Example: A lady was walking on the pathway with a leashed dog (characters lady, dog and actions to move).

12. The ability to simulate time and location specific capabilities. Example: 5:00 pm in the evening or midday via environment to media map.

13. The ability to run the sequence of events and highlight root cause for accident or events textually as well as media wise. The system will also provide a correlation based on various events, mapping and creation of event sequences based on self-learning from historical data points and models in the repository or data collector 100. For example, in a vigilance investigation, the system may possess the ability to build the proceedings, build the case, and compare and highlight discrepancies.

The event processing server 135 is capable of providing an initial event assessment by processing user data and output any discrepancies. In an exemplary embodiment, the system server 115 and the event processing server 135 can include various routines, sub-routines, programs, objects, components, data structures, etc., which perform particular tasks or implement particular abstract data types. The exemplary event processing server 135 can facilitate the collection and processing of data from the user 105 necessary for completing an event evaluation that searches for any discrepancies. The event processing server 135 can send and receive data between the user 105 and the system server 115 via the network 120 or a web browser. As provided above, user data can take the form of text and images. The event server 115 can provide an interface with the user and its associates, including, for example, a claim agent, a repair facility, a police chief or other police officers, the court and any other person required to access the user data and user created data regarding the event. The exemplary event processing server 135 may query the user 105 to provide additional and/or supplemental information regarding the event. The request for additional information can be provided in response to an event query and/or a third-party query. The exemplary event processing server 135 can also request additional/supplemental information in response to identification deficiencies in the quantity or quality of data received, as determined by the event processing server 135. For example, the event processing server 135 can determine when there is sufficient information with respect to the weather and/or traffic data to process and finalize the evaluation of the event.

The exemplary event processing server 135 may also generate a two-dimensional (2D) and/or three-dimensional (3D) model of an object or scene associated with the event. In an exemplary embodiment, user data, such a photos or video images of the object, is used by the event processing server 135 can create a dynamic 3D model and/or rendering of the object or scene. To create the model, the event processing server 135 can utilize various methods of imaging processing including, for example, edge detection, 3D scanning, stereoscopic imaging, or any other 3D modelling method known in the art. For example, the event processing server 135 can create a 3D model/rendering of the object by combing or overlaying multiple still images and/or video images of the object taken from different positions. In the example of a car accident, the event processing server 135 can generate a dynamic 3D model of the car using still or video images captured by the user 105. It is also contemplated that the event processing server 135 can generate 3D models of another party's car, or any other object that is relevant to the event. In an exemplary embodiment, the event processing server 135 may use stored data regarding the object to generate the 3D model. Stored data regarding the object can include, for example, reference 2D/3D model information for the same or similar object. In an exemplary embodiment where the user device 110 does not include a functioning camera or is otherwise incapable of capturing images of the object, the event processing server 115 will recognize that no image data is available from the user 105 and provide a model of the object based on stored image data of the same or similar objects. In an embodiment involving a car accident, if there is no image data available the event processing server 135 may use stored image data of a car having the same make/model as the user's 105 car to generate the model for display and use by the user 105. In an alternate embodiment, the event processing server 135 may use stored data regarding the object to supplement the image data provided by the user 105. For example, if the user 105 provides incomplete or poor quality image data, the event processing server 135 may supplement and/or replace the user-provided image data with stored image data of the same or similar object. In the embodiment involving a car accident, if the user image data is incomplete/inadequate, the event processing server 135 may use stored image data of the same make/model of the user's car to supplement the user-captured images and generate the model.

An exemplary event processing server 135 can generate a 2D and/or 3D model of the scene associated with an insurance claim. For example, using user data, such as photos or video images of the scene, the event processing server 135 can create a dynamic 3D model and/or rendering of the scene and display the model to the user 105 via the user device 110. To create the scene model, the event processing server 135 uses similar methods of image processing as those used to model the object. For example, in the case of a car accident, the event processing server 135 can generate a dynamic 3D model of the scene of the accident using still or video images captured by the user 105. In an exemplary embodiment, the event processing server 135 may use stored data regarding the scene to generate the model. Stored data regarding the scene can include, for example, a 2D/3D map of the scene, topographical information, municipality information (location of pedestrian cross-walks, posted speed limits, traffic signals, etc.), and any other information relevant to generating the model. In an alternate embodiment, the event processing server 135 can use the stored scene data to supplement and/or replace the user-provided image data. For example, if the user 105 provides incomplete or poor quality image data, the event processing server 135 may supplement and/or replace the user-provided image data with stored image data of the scene.

It is contemplated that the user device 110 may also include one or more similar computer system components described with respect to the system server 115. Those having ordinary skill in the art having the benefit of the present disclosure will appreciate that the system server 115 and the user device 110 can have any of several other suitable computer system configurations.

In addition or in the alternative, data may be synchronized with a remote storage location, such as a cloud computing environment (not shown). In such an embodiment, the user 105 can access the information stored at the remote location using the user device 110 or another device, such as a desktop computer connected via the network 120. The system server 115 can access the computing environment via the network 120. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 4a illustrates a flowchart for employing the cognitive approach to event verification in accordance with another embodiment of the present invention. In accordance with this invention, cognitive inferences may be created based on historical data, building an evolving repository of instruction-action linkages mapping behavioral actions, in the context of surrounding variables, such as user data, behavioural history, weather conditions, situational data (such as tone, mood etc.), geographic or location data, etc. The system 100 uses a continuous feedback loop 600 in FIG. 4a by which the system 100 observes data sets in the form of machine data. The system 100 identifies the level of variance in terms of observed actions and outcomes to determine the association with new patterns or existing patterns and scores the data using cognitive analysis, based on input from a case history, user activity, known risks and so on.

The following step-by-step process set forth one embodiment to accomplish the objective of this invention. First, data is aggregated from multiple data points, such as weather factors 601, behavioural historical data 602, mood analysis 603, legal and regulatory database 604, user characteristics and traits 605, sensor data 606, local and weather data 607, stimulator data 608, and social profile (e.g., social media data). This information is stored, for example, in an historical database 610. The system 100 then identifies and validates the case history data by cross-checking related data for factual inconsistencies, and verifies the case history. Further, the system 100 maps the case history data to various factors. The system 100 then uses the data collected from sources 601-609 to establish or derive a unique pattern at 620 for the event at hand based on these multiple data points (601-609). The unique pattern 620 is compared to existing patterns 630 to validate the facts.

Inferences may be created based on self-learning, reasoning and different external factors (e.g., users profile, tone of user, mood of user, behavior pattern of users, user's driving history) using data aggregation from the database 610. The feedback loop 600 is applied to all data points 601-609 and historical data 610 with proper reasoning by reasoning module 640. The system 100 maintains and updates the cognitive events list or pattern repository 650 by receiving both the new or unique patterns 620 and the existing patterns database 630, which both take advantage of the reasoning module 640 to reach inferences about the event data. The system 100 is constantly receiving new and additional data based on new dimension and attributes based on new and unique events 620 in real time with dynamic characteristic of on-going data analysis and comparison. Thus, the system 100 provides dynamic adjustment based on self-reasoning and data augmentation based on the detected changes in external data attributes.

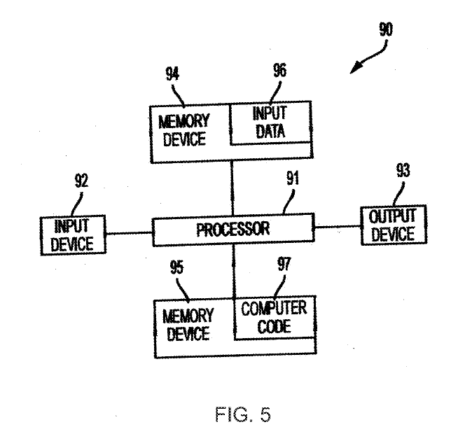

FIG. 5 illustrates a computer system 90 used for implementing the methods of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97 which is a computer program that includes computer-executable instructions. The computer code 97 includes software or program instructions that may implement an algorithm for implementing methods of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may be used as a computer usable storage medium (or program storage device) having a computer readable program embodied therein and/or having other data stored therein, wherein the computer readable program includes the computer code 97. Generally, a computer program product (or, alternatively, an article of manufacture) of the computer system 90 may include the computer usable storage medium (or said program storage device).

The processor 91 may represent one or more processors. The memory device 94 and/or the memory device 95 may represent one or more computer readable hardware storage devices and/or one or more memories.

Thus the present invention discloses a process for supporting, deploying and/or integrating computer infrastructure, integrating, hosting, maintaining, and deploying computer-readable code into the computer system 90, wherein the code in combination with the computer system 90 is capable of implementing the methods of the present invention.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method of verifying factual accuracy of an event, said method comprising the steps of:
receiving, by a computer, event data into an event program, said event data including actor data related to at least one actor involved in an event and location data related to a location of said event;
creating, by the computer, a factual scenario based on said event data;
performing, by the computer, a cognitive reasoning and analysis of said event data to derive inferences regarding said event;
composing, by the computer, a time-sequenced series of inferences based on said cognitive reasoning and analysis of said event data, said inferences being derived from past events stored on said computer, said past events having historical data sharing at least one factual element with said event data;
validating, by the computer, an integrity of said event data by comparing a plurality of data points from different sources being received as said event data;
identifying, by the computer, an instance of factual inconsistency having been recognized by said step of validating said integrity, said factual inconsistency being conflicting information in said data points;
prompting, by the computer, at least one flag noting said factual inconsistency; and
outputting, by the computer, a rendering of said event based on said factual scenario and said time-sequenced series of inferences, said rendering including rendering said flag generated during said step of prompting to identify said factual inconsistency.

2. The method of claim 1, further comprising:
analyzing, by a cognitive modeler module of the computer, said event data to hypothesize at least one possible scenario related to said event, said step of analyzing including predicting future actions based on said event data.

3. The method of claim 1, further comprising:
analyzing, by the computer, a behavior of said at least one actor during said event, said behavior including comparison of said event data with an historical database of related activities of said at least one actor.

4. The method of claim 3, further comprising:
building, on the computer, a behavior profile for said at least one actor based on said event data, said behavior profile being based on cognitive analysis of said behavior and said event data.

5. The method of claim 4, further comprising:
transforming metadata received by a raw data processor from disparate sources into a cohesive data structure; and
delivering said transformed metadata to a data segment analyzer to derive said behavior profile.

6. The method of claim 1, further comprising:
receiving by a data collector module of the computer said event data, said event data being received from at least one of sensor data module associated with said location, a traffic data module associated with said location, a weather data module associated with said location, a personal history data module associated with said actor, and a legal and regulatory module associated with said location.

7. The method of claim 1, further comprising:
validating said event data against at least one of legal and regulatory data received by said data collector module.

8. The method of claim 1, further comprising:
assigning at least one textual label to said event data received by the data collector module, said at least one textual label identifying significant facts relevant to said event.

9. The method of claim 1, further comprising:
generating said rendering to include at least one of text, video and audio data compiled by said the computer based on said event data.

10. The method of claim 1, further comprising:
comparing a plurality of witness statements; and
identifying any factual inconsistency between said plurality of witness statements.

11. A computer program product comprising:
a computer-readable storage device; and
a computer-readable program code stored in the computer-readable storage device, the computer readable program code containing instructions executable by a processor of a computer system to implement a method of verifying factual accuracy of an event, the method comprising:
receiving event data into an event program, said event data including actor data related to at least one actor involved in an event and location data related to a location of said event;
creating a factual scenario based on said event data;
performing a cognitive reasoning and analysis of said event data to derive inferences regarding said event;
composing a time-sequenced series of inferences based on said cognitive reasoning and analysis of said event data, said inferences being derived from past events stored on said computer, said past events having historical data sharing at least one factual element with said event data;
validating an integrity of said event data by comparing a plurality of data points from different sources being received as said event data;
identifying an instance of factual inconsistency having been recognized by said step of validating said integrity, said factual inconsistency being conflicting information in said data points;
prompting at least one flag noting said factual inconsistency; and
outputting a rendering of said event based on said factual scenario and said time-sequenced series of inferences, said rendering including rendering said flag generated during said step of prompting to identify said factual inconsistency.

12. The computer program product of claim 11, further comprising:
analyzing, by a cognitive modeler module of the computer, said event data to hypothesize at least one possible scenario related to said event.

13. The computer program product of claim 11, further comprising:
analyzing, by the computer, a behavior of said at least one actor during said event.

14. The computer program product of claim 13, further comprising:
building, on the computer, a behavior profile for said at least one actor based on said event data, said behavior profile being based on cognitive analysis of said behavior and said event data.

15. The computer program product of claim 14, further comprising:
transforming metadata received by a raw data processor from disparate sources into a cohesive data structure; and
delivering said transformed metadata to a data segment analyzer to derive said behavior profile.

16. The computer program product of claim 11, further comprising:
receiving by a data collector module said event data, said event data being received from at least one of sensor data module associated with said location, a traffic data module associated with said location, a weather data module associated with said location, a personal history data module associated with said actor, and a legal and regulatory module associated with said location.

17. The computer program product of claim 11, further comprising:
validating said event data against at least one of legal and regulatory data received by said data collector module.

18. A computer system for verifying factual accuracy of an event, the system comprising:
a central processing unit (CPU);
a memory coupled to said CPU; and
a computer readable storage device coupled to the CPU, the storage device containing instructions executable by the CPU via the memory to implement a method of creating a virtual object, the method comprising the steps of:
receiving event data into an event program, said event data including actor data related to at least one actor involved in an event and location data related to a location of said event;
creating a factual scenario based on said event data;
performing a cognitive reasoning and analysis of said event data to derive inferences regarding said event;
composing a time-sequenced series of inferences based on said cognitive reasoning and analysis of said event data, said inferences being derived from past events stored on said computer, said past events having historical data sharing at least one factual element with said event data;
validating an integrity of said event data by comparing a plurality of data points from different sources being received as said event data;
identifying an instance of factual inconsistency having been recognized by said step of validating said integrity, said factual inconsistency being conflicting information in said data points;
prompting at least one flag noting said factual inconsistency; and
outputting a rendering of said event based on said factual scenario and said time-sequenced series of inferences, said rendering including rendering said flag generated during said step of prompting to identify said factual inconsistency.

19. The computer system of claim 18, further comprising:
analyzing, by a cognitive modeler module of the computer, said event data to hypothesize at least one possible scenario related to said event.

20. The computer system of claim 18,
analyzing, by the computer, a behavior of said at least one actor during said event; and
building, on the computer, a behavior profile for said at least one actor based on said event data, said behavior profile being based on cognitive analysis of said behavior and said event data.
